(19) United States
(12) Patent Application Publication
(10) Pub. No.: US 2007/0232226 A1
(43) Pub. Date: Oct. 4, 2007

(54) Digital Broadcast Reception Device

(75) Inventor: Ichiro Kajitani, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 11/597,020

(22) PCT Filed: May 16, 2005
(86) PCT No.: PCT/JP05/08896

§ 371 Date: Nov. 17, 2006

(30) Foreign Application Priority Data
May 21, 2004 (JP) 2004-152430

(51) Int. Cl. H04B 3/36

(52) U.S. Cl. 455/7

(57) ABSTRACT

[Object] To provide a digital broadcast reception device capable of improving user-friendliness concerning information acquisition by a user, even when a state in which video of a program cannot be displayed is caused.

[Solution] A CPU displays on a screen a message of “unable to receive” when the video of the program cannot be displayed. Furthermore, the CPU extracts program information from PSI/SI which has been acquired during reception of the program, and displays on the screen a broadcast station name, a channel number, a channel title, etc. In addition, if the program information contains URI, that is, a browsing destination of a program Website, the CPU displays a program Website button for selecting the URI. When the user operates the program Website button, an Internet connection process is performed through a PHS data card. As a result, an image based on a received file is displayed on an LCD panel (202).

### FIELD OF THE INVENTION

The present invention relates to a digital broadcast reception device for receiving a digital broadcast.

### DESCRIPTION OF RELATED ART

Digital broadcast reception devices for receiving a digital broadcast using a satellite or a terrestrial wave selects by a tuner an arbitrary broadcast wave from the plurality of broadcast waves received through a dedicated antenna or a terrestrial wave-use antenna, selects by demultiplexing processing an arbitrary channel from the plurality of channels included in the selected broadcast wave, and decodes a digital signal produced from the selected channel, to output a video-audio signal. In addition, recently, it has become possible to view a digital television broadcast by mobile terminals such as a mobile telephone (see Japanese Patent Laying-open No. 2003-101898, and Japanese Patent Laying-open No. 2000-332632).

### DISCLOSURE OF THE INVENTION

### Problem to be Solved by the Invention

Incidentally, when receiving a digital broadcast, video of the program cannot be displayed due to reasons that a radio wave cannot be received, or a packet is lacked, for example. In this case, a message indicating “unable to receive” should be displayed. This, however, causes a user to feel dissatisfied in terms of user-friendliness.

In view of the above circumstance, it is an object of the present invention to provide a digital broadcast reception device capable of improving user-friendliness concerning information acquisition by a user, even when a state in which video of a program cannot be displayed is caused.

### MEANS FOR SOLVING PROBLEM

A digital broadcast reception device of the present invention is a digital broadcast reception device for obtaining various data by receiving a digital broadcast, and comprises means for determining whether a state in which video of a program cannot be displayed or not, and means for displaying on a screen, program information of the program obtained as the various data, upon determination that the video of the program cannot be displayed.

In addition, a digital broadcast reception device of the present invention is a digital broadcast reception device for obtaining various data by receiving a digital broadcast, and comprises means for determining whether a state in which video of a program cannot be displayed or not, and means for displaying on a screen, commercial message information obtained as the various data, upon determination that the video of the program cannot be displayed.

Furthermore, a digital broadcast reception device of the present invention is a digital broadcast reception device for obtaining various data by receiving a digital broadcast, and comprises means for determining whether a state in which video of a program cannot be displayed or not, and means for displaying on a screen, one or a plurality of scene images of the program obtained as the various data, upon determination that the video of the program cannot be displayed.

In addition, a digital broadcast reception device of the present invention is a digital broadcast reception device for obtaining various data by receiving a digital broadcast, and comprises means for determining whether a state in which video of a program cannot be displayed or not, and means for displaying on a screen, data of a data broadcast obtained as the various data, upon determination that the video of the program cannot be displayed.

The digital broadcast reception device of these configurations can improve user-friendliness concerning information acquisition by a user, even when a state in which video of a program cannot be displayed is caused.

The digital broadcast reception device of these configurations may comprise means for connecting to a network, and means for browsing a received file, in which a button based on Website connection information obtained as the various data is displayed on the screen, upon determination that the video of the program cannot be displayed, and a network connection is performed when a user operates the button, thereby displaying the received file on the screen. In addition, in the digital broadcast reception device, a button for applying a predetermined instruction to the digital broadcast reception device may be displayed on the screen upon determination that the video of the program cannot be displayed. Furthermore, an image received last in a receivable state may be displayed for a predetermined time period, before a process performed upon determination that the video of the program cannot be displayed. In addition, a plurality of selectable processes as processes performed upon determination that the video of the program cannot be displayed are previously prepared, and a process specified in advance by the user may be executed. Furthermore, a plurality of selectable processes as processes performed upon determination that the video of the program cannot be displayed are previously prepared, and a process, out of the plurality of processes, chosen by the program may be executed.

### EFFECT OF THE INVENTION

According to the present invention, it is possible to improve user-friendliness concerning information acquisition by a user, even when video of a program cannot be displayed.

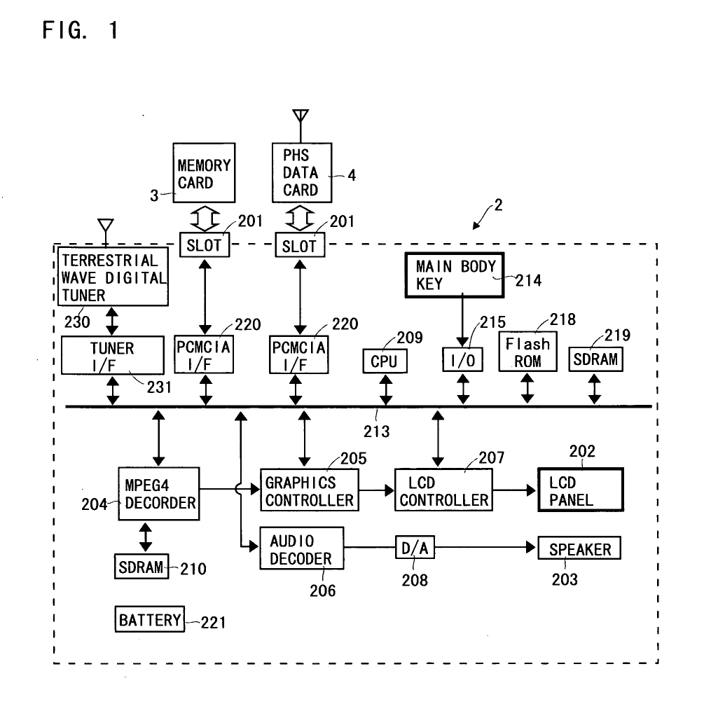

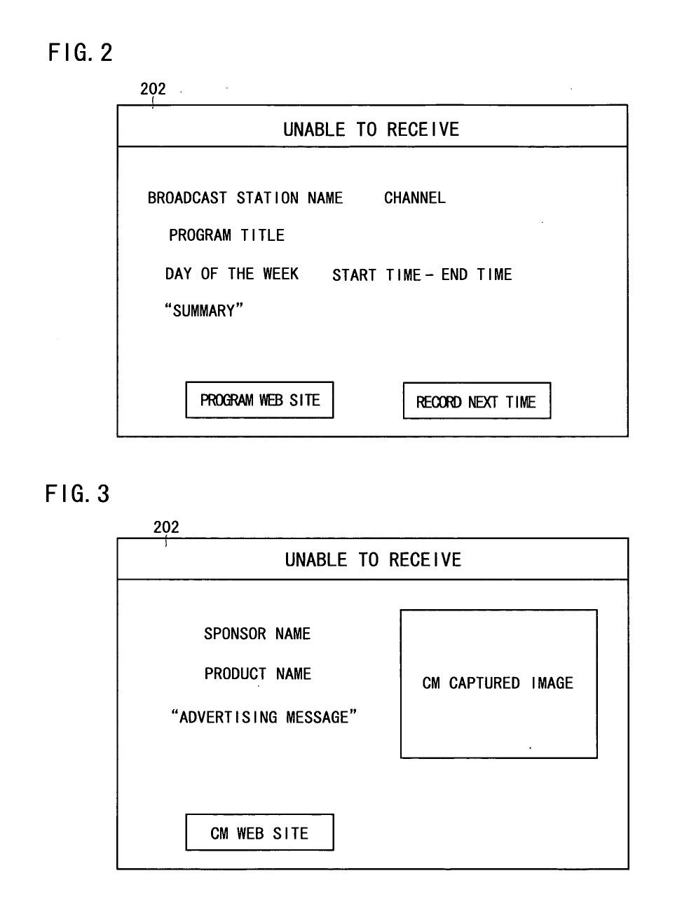

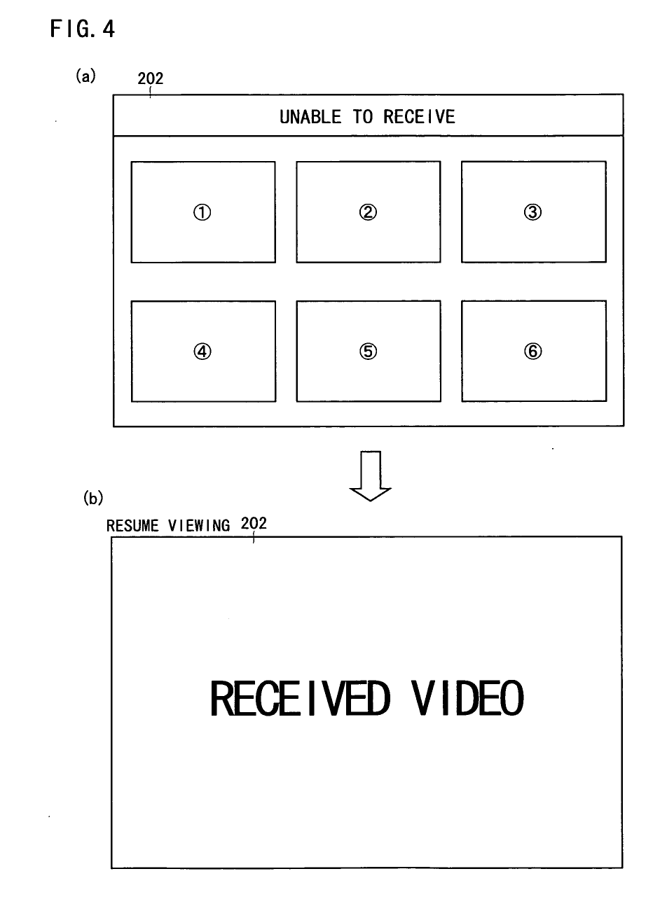

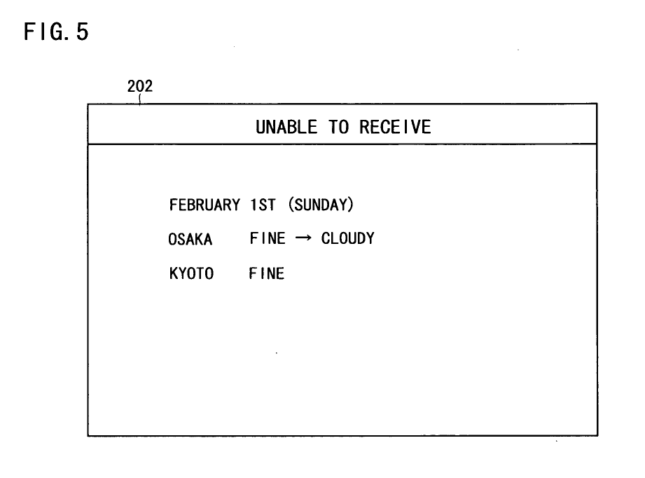

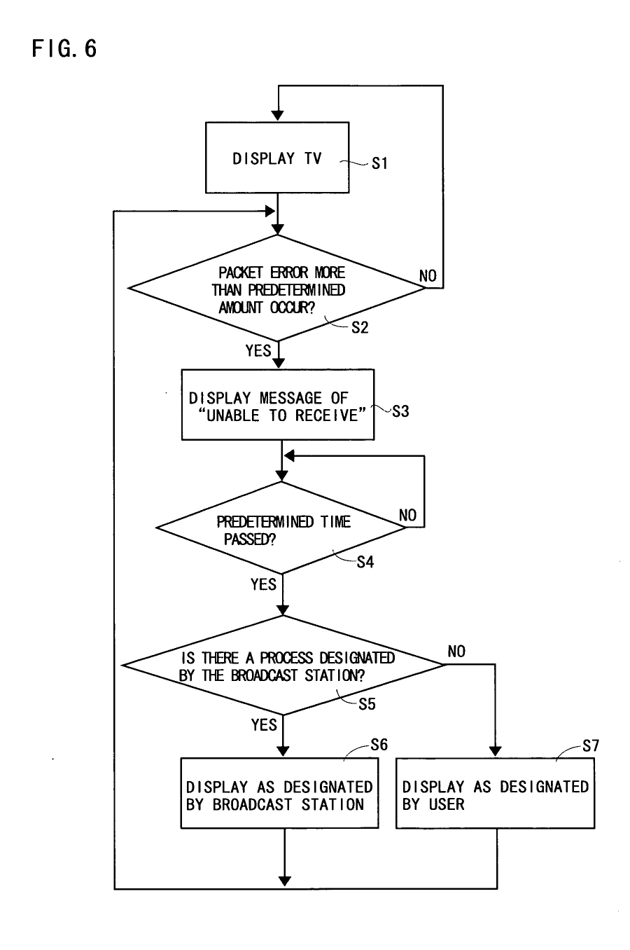

### BRIEF DESCRIPTION OF THE DRAWINGS

[FIG. 1] A block diagram showing a structure of a mobile-type digital broadcast reception device of an embodiment of the present invention;

[FIG. 2] An explanatory diagram showing a display screen example when video of a program cannot be displayed;

[FIG. 3] An explanatory diagram showing a display screen example when video of a program cannot be displayed;

[FIG. 4(a)] An explanatory diagram showing a display screen example when video of a program cannot be displayed;

[FIG. 4(b)] An explanatory diagram of a screen when viewing is resumed;

[FIG. 5] An explanatory diagram showing a display screen example when video of a program cannot be displayed; and

[FIG. 6] A flowchart showing an example of a process.

### DESCRIPTION OF THE NUMERALS

2 digital broadcast reception device

202 LCD panel

205 graphics controller

207 LCD controller

209 CPU

230 terrestrial wave digital tuner

### BEST MODE FOR PRACTICING THE INVENTION

Hereinafter, an embodiment of the present invention will be described referring to FIG. 1 to FIG. 6.

FIG. 1 is a block diagram showing a mobile-type digital broadcast reception device of this embodiment.

Based on coded video-audio data obtained as a result of a terrestrial wave digital tuner 230 and a tuner I/F (interface) 231 receiving broadcast, or based on coded video-audio data read out from a memory card 3, and others, inserted to a slot 201, the digital broadcasting reception device 2 displays a video on a liquid crystal display panel 202, and outputs an audio from an speaker 203, as shown in FIG. 1. In addition, the digital broadcast reception device 2 is also capable of recording into the memory card 3, etc., the coded video-audio data obtained by broadcasting reception of the terrestrial wave digital tuner 230. In addition to moving video recording, this recording includes recording of still video (I picture, for example) selected under a predetermined condition (capture process). In the still image recording, six pieces of received images are recorded and overwritten one after another, or determination is made as to whether a commercial message is broadcast so that images of the commercial message are recorded, for example.

It is noted that in this embodiment, the above-described coded video-audio data is MPEG4 data, for example. In addition, a CPU 209 is supplied with a transport stream. Upon interpretation of the input transport steam, the CPU 209 applies a video stream to an MPEG decoder 204, and an audio stream to an audio decoder (MPEG4-AAC) 206. The CPU 209 separates PSI/SI (Program Specific information/Service information) from the input transport steam so that it is stored in a memory.

Furthermore, the MPEG4 data read out from the memory card 3 is applied to the MPEG4 video decoder 204 via a PCMCIA interface 220 and a system bus 213.

The MPEG4 video decoder 204 supplies video data to a graphics controller 205. This video data is obtained by evaluation of a quantization coefficient and a motion vector by decoding MPEG4 bit stream data, followed by performing an inverse DCT conversion and a motion compensation control based on the motion vector, and others. The graphics controller 205 subjects the video data (R, G, B data, for example) to processes for adjusting colors, and so on. In addition, the graphics controller 205 also performs an OSD (on-screen display) process for displaying, on the liquid crystal display panel 202, text and others that the CPU 209 instructs to output. This OSD process allows various messages to be displayed. In addition, the graphics controller 205 is capable of performing various processes such as a process for reducing in size the screen size of broadcast received video (scaling process), a process for displaying a plurality of pieces of captured still images in a single screen. An audio decoder 206 decodes the coded audio data in the bit stream to generate audio data. An SDRAM 210 is used for the above process by the MPEG 4 video decoder 204.

An LCD controller 207 drives the LCD panel 202 based on the video data applied from the graphics controller 205. Upon receiving the audio data output from the audio decoder 206, a D/A converter 208 applies a D/A (digital to analog) conversion on the received audio data so as to generate analog signals for a right (R) audio and a left (L) audio. These signals are supplied to the speaker 203.

Operation information toward keys 214 provided on a main body is applied to the CPU 209 via an interface 215 and the system bus 213. The CPU 209 executes a necessary process based on the above operation information. The keys 214 provided on the main body main body includes, besides a number keypad, etc., a cross key (direction key) for selecting a button displayed on a screen, and an enter key.

In addition, the digital broadcast reception device 2 also includes a FlashROM 218, and an SDRAM 219. The FlashROM 218 stores various setting information set by a user, for example. A battery 221 is a rechargeable battery, and is supplied with electric power from a battery charger not shown so as to charge itself.

The CPU 209 is designed for performing various processes such as a data transmission (including a Internet connection process (browser start-up), and electronic mail transmission) using a PHS data card attached to the slot 201, control of each functional portion based on the received data, control of reading or writing to or from the FlashROM 218 and the SDRAM 219. Because of the function of the above browser, the digital broadcast reception device can connect to various Websites such as a program Website, a CM (commercial message) Website for displaying an image based on a certain file on the LCD panel 202.

Next, processes in a case where video of a program cannot be displayed will be described as follows. For determining whether or not the video of the program cannot be displayed, intensity of received electrical field in the tuner 230, a correction situation of a data error, for example, can be checked.

(1) The CPU 209 displays on the screen a message of “unable to receive” when the video of the program cannot be displayed. Furthermore, the CPU 209 extracts program information from the PSI/SI which has been acquired during reception of the program, and displays on the screen a broadcast station name, a channel number, a program title, etc., as shown in FIG. 2. In addition, the CPU displays a program Website button for selecting URI (Uniform Resource Identifier) as a browsing destination of a program Website if there is the URI in the program information, and displays a recording reservation button for encouraging the user to record the same program for the next time.

When the user operates the program Website button, the CPU 209 connects Internet by using the PHS data card 4, and displays on the LCD panel 202 the video based on the received file. In addition, when the user operates the recording reservation button, the CPU 209 performs the recording reservation process based on the program information in the PSI/SI. When the video of the program becomes displayable, a video display process of the received program can be performed, or the video display process of the received program can be performed when a “YES button” is operated after a message of “Now able to receive. Do you receive?” and a button of “YES or NO” are displayed. Or the video display process of the received program can be performed when LED, etc., or one portion of the screen is blinked, and thereafter, a predetermined key is operated. The CPU 209 recognizes the operations on the button displayed on the screen as below. That is, the CPU 209 can recognize the operation by a signal from a touch panel in such case the touch panel is provided, or by a signal from a main body's key when the button is displayed corresponding to a position, etc., of the main body's key (a so-called soft key), or based on a position of a cursor in a case where the cursor is placed over the button by a direction key (cross key), etc., of the main body, and then, the enter key is depressed.

(2) When the video of the program cannot be displayed, the CPU 209 displays on the screen a message of “unable to receive”. Furthermore, the CPU 209 acquires commercial message (CM) information (text information, image information, and captured image) which has been acquired during reception of the program, and displays on the screen a sponsor name, a product name, an advertising message, etc., as shown in FIG. 3. In addition, the CPU 209 displays a CM Website button for selecting URI (Uniform Resource Identifier) as a browsing destination of a CM Website if there is the URI in the program information. When the user operates the CM site button, the CPU 209 connects the Internet by using the PHS data card 4, and displays on the LCD panel 202 the image based on the received file. When the video of the program becomes displayable, the above process described in the above (1) may be performed.

(3) When the video of the program cannot be displayed, the CPU 209 displays on the screen a message of “unable to receive”. Furthermore, as shown in FIG. 4(a), the CPU 209 displays on the screen a plurality of captured still images (program scenes) which have been acquired during reception of the program. When the video of the program becomes displayable, the video display process of the received program is performed as shown in FIG. 4B(b).

(4) When the video of the program cannot be displayed, the CPU 209 displays on the screen a message of “unable to receive”. Furthermore, as shown in FIG. 5, the CPU 209 displays on the screen a weather forecast which have been acquired during reception of the program. Information on the weather forecast may be obtained as data of data broadcast that accompanies the program, for example. When the video of the program becomes displayable, the video display process in the above (1) may be performed. Besides the weather forecast, another information such as news may be displayed.

The user can set start timing (such as whether or not the process is started immediately after the video of the program cannot be displayed, whether or not the process is started when the state in which video of the program cannot be displayed continues for a predetermined time period, how long does it last to be defined as the predetermined time period) of the processes of (1) to (4). In addition, regarding which of these processes of (1) to (4) to be adopted, the user can determined by the user setting. On the other hand, a broadcast station can determine which of these processes of (1) to (4) is adopted (designated by the program). That is, when the video of the program cannot be displayed, the broadcast station may specify what kind of information to be offered to the user, which replaces the video of the program. This designation may be realized by including the information in the program information in advance. The digital broadcast reception device 2 may preferably prepare an API (Application Programming Interface) in its OS (operating system) in order to execute a process corresponding to the above designation process. The process designated by the user may be performed when the broadcast station does not specify any process. In addition, before a process performed upon determination that the video of the program cannot be displayed, a display of the last image may be performed for a predetermined time period. This predetermined time period, too, is preferably set by the user.

FIG. 6 is a flowchart showing an example of a television display process. When if there are packet errors of a predetermined number or more when the digital broadcast is being received (step S1, and YES in a step S2), a message of “unable to display” is displayed (step S3). When a predetermined time period passes after this display (YES in a step S4), the CPU 209 determines whether or not there is a process designated by the broadcast station (process designated by the program) (step S5). If there is the process, the CPU 209 performs a process according to an instruction of the broadcast station (step S6), and if there is no process, the CPU 209 executes a process specified in advance by the user (step S7). It is noted that in a case that there is no process specified in advance, the CPU 209 may display a list of contents to be performed so that the user is allowed to choose the content from the list.

It is noted that in the above example, an example of a configuration in which the digital broadcast reception device is a mobile type (mobile telephone, PDA, etc.) is shown. However, it may be configured such that the digital broadcast reception device is a car-mounted digital broadcast reception device, or is a stationary digital broadcast reception device, etc.

What is claimed:

1. A digital broadcast reception device for obtaining various data by receiving a digital broadcast, comprising:
means for determining whether a state in which video of a program cannot be displayed or not; and
means for displaying on a screen, program information of the program obtained as the various data, upon determination that the video of the program cannot be displayed.

2. A digital broadcast reception device for obtaining various data by receiving a digital broadcast, comprising:
means for determining whether a state in which video of a program cannot be displayed or not; and
means for displaying on a screen, commercial message information obtained as the various data, upon determination that the video of the program cannot be displayed.

3. A digital broadcast reception device for obtaining various data by receiving a digital broadcast, comprising:
means for determining whether a state in which video of a program cannot be displayed or not; and
means for displaying on a screen, one or a plurality of program scene images obtained as the various data, upon determination that the video of the program cannot be displayed.

4. A digital broadcast reception device for obtaining various data by receiving a digital broadcast, comprising:
means for determining whether a state in which video of a program cannot be displayed or not; and
means for displaying on a screen, data of a data broadcast obtained as the various data, upon determination that the video of the program cannot be displayed.

5. A digital broadcast reception device according to any one of claims 1 to 4, comprising:
means for connecting to a network; and
means for browsing a received file, wherein
a button based on resource specifying information obtained as the various data is displayed on the screen, upon determination that the video of the program cannot be displayed, and
a network connection is performed when a user operates the button, thereby displaying the received file on the screen.

6. A digital broadcast reception device according to any one of claims 1 to 4, wherein a button for applying a predetermined instruction to the reception device is displayed on the screen, upon determination that the video of the program cannot be displayed.

7. A digital broadcast reception device according to any one of claims 1 to 4, wherein an image received last in a receivable state is displayed for a predetermined time period, before a process performed upon determination that the video of the program cannot be displayed.

8. A digital broadcast reception device according to any one of claims 1 to 4, wherein a plurality of selectable processes as processes performed upon determination that the video of the program cannot be displayed are previously prepared, and a process specified in advance by the user is executed.

9. A digital broadcast reception device according to any one of claims 1 to 4, wherein a plurality of selectable processes as processes performed upon determination that the video of the program cannot be displayed are previously prepared, and a process, out of the plurality of processes, previously chosen by the program is executed.
